(19) United States
(12) Patent Application Publication
(10) Pub. No.: US 2015/0313099 A1
(43) Pub. Date: Nov. 5, 2015

(54) GARDENING BED

(71) Applicant: North Carolina State University, Raleigh, NC (US)

(72) Inventors: Rachel A. Whitaker, Raleigh, NC (US); Percy R. Hooper, JR., Cary, NC (US)

(21) Appl. No.: 14/268,093

(22) Filed: May 2, 2014

(51) Int. Cl. A01G 27/00; A01G 27/06

(52) U.S. Cl. CPC A01G 27/00; A01G 27/06

(57) ABSTRACT

A gardening bed includes a frame and a structural panel coupled to the frame. The panel includes at least two interconnected layers of polymer material, at least one channel defined between the layers, the channel having an opening into which a fluid may be poured, and at least one reservoir defined between the layers in which fluid poured through the channel may accumulate.

### FIELD OF THE INVENTION

The present invention relates to planters, and more particularly to raised bed planters having means for wicking water from a reservoir into the planter.

### BACKGROUND OF THE INVENTION

Wicking or self-watering planters typically include an enclosure for receiving soil and plant material therein, a reservoir for storing water, and at least one wick extending between the reservoir and the soil for diffusing water from the reservoir into the soil.

### SUMMARY OF THE INVENTION

The invention provides, in one aspect, a gardening bed including a frame and a structural panel coupled to the frame. The panel includes at least two interconnected layers of polymer material, at least one channel defined between the layers, the channel having an opening into which a fluid may be poured, and at least one reservoir defined between the layers in which fluid poured through the channel may accumulate.

The invention provides, in another aspect, a structural panel for a gardening bed. The structural panel includes a first portion, a second portion extending generally perpendicularly from the first portion, and at least one channel extending through the first portion. The channel has an opening into which a fluid may be poured and at least one reservoir in which fluid poured through the channel may accumulate.

Other features and aspects of the invention will become apparent by consideration of the following detailed description and accompanying drawings.

### BRIEF DESCRIPTION OF THE DRAWINGS

FIG. 1 is a perspective view of a gardening bed in accordance with an embodiment of the invention.

FIG. 2 is an exploded view of the gardening bed of FIG. 1.

FIG. 3 is an enlarged perspective view of a portion of a structural panel of the gardening bed of FIG. 1.

FIG. 4 is a cross-sectional view of the gardening bed taken along line 4-4 in FIG. 1.

FIG. 5 is a perspective view of water being poured into a structural panel of the gardening bed of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

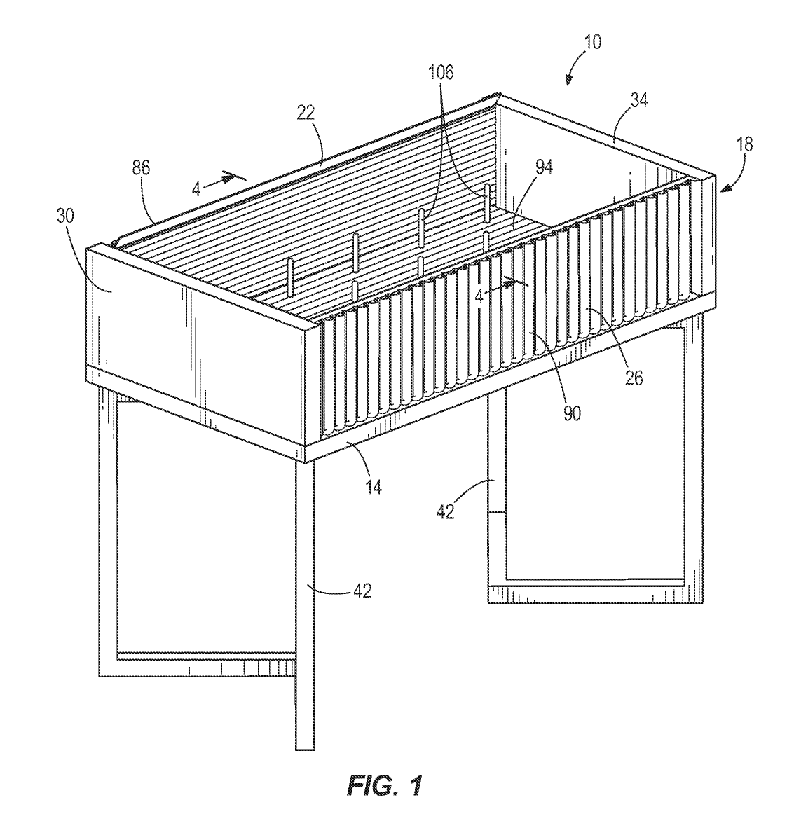

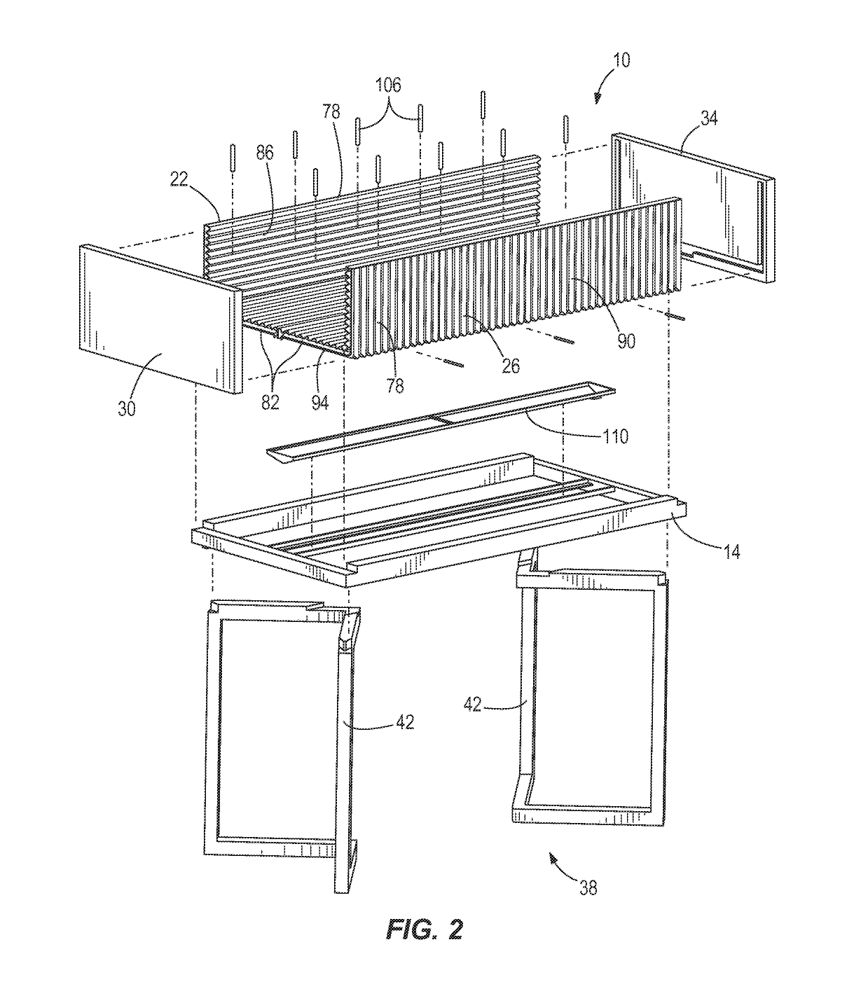

FIGS. 1 and 2 illustrate a gardening bed 10 including a frame 14 and an enclosure 18 supported on the frame 14 and configured to receive soil and plant matter therein. The enclosure 18 is defined by first and second structural side panels 22, 26, and first and second spaced end panels 30, 34 coupled to the frame 14. A stand 38 including a pair of generally V-shaped support members 42 may support the gardening bed 10 in an elevated position. In some embodiments, the stand 38 may be removed to allow the gardening bed 10 to be positioned directly on a ground surface.

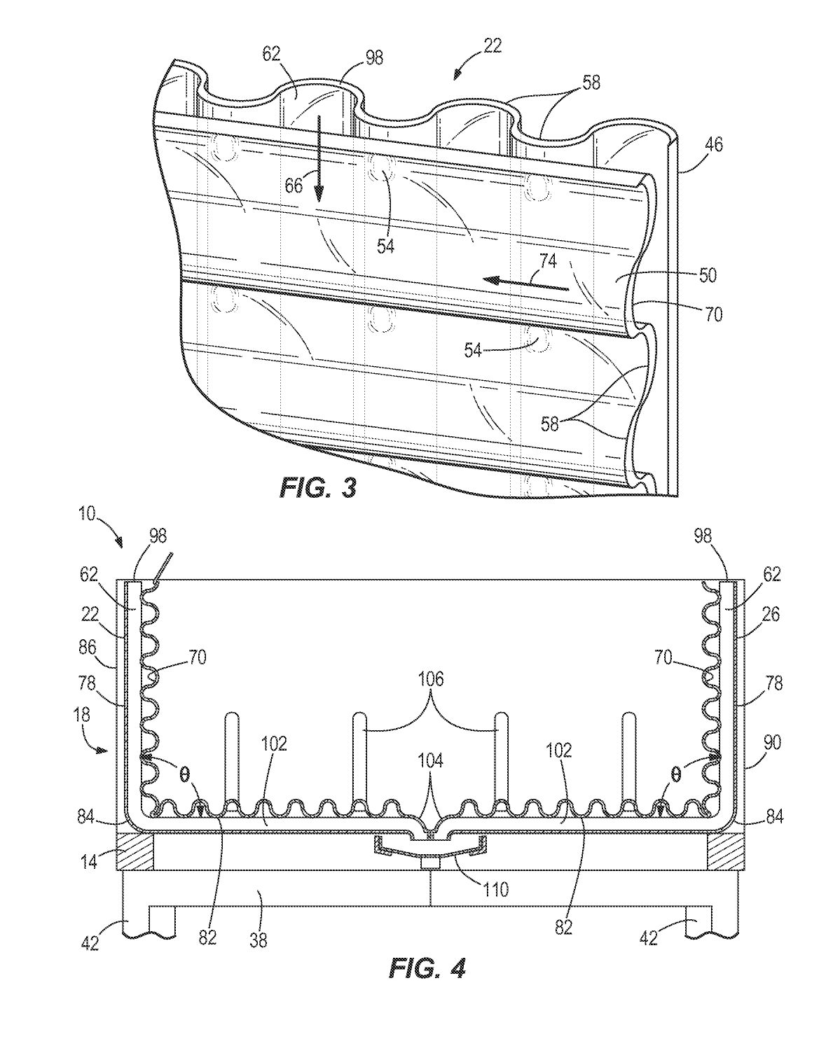

With reference to FIG. 3, the structural side panels 22, 26 are made of first and second interconnected sheets 46, 50 of a heat-shrinkable polymer material. The interconnected sheets 46, 50 may define a self-corrugating polymer panel such as those described in U.S. Patent Application Publication Nos. 2014/0087145, 2014/0087146, and 2014/0087147, the entire contents of all of which are incorporated herein by reference.

Before assembling the enclosure, each of the sheets 46, 50 is uniaxially stretched to impart direction or orientation in the polymer chains. The sheets 46, 50 are oriented so that the stretched direction of the first sheet 46 is generally perpendicular to the stretched direction of the second sheet 50. A radio frequency (RF) or other suitable welding process is used to create weld spots 54 that permanently bond the sheets 46, 50 at evenly-spaced intervals. The sheets 46, 50 are then heated, causing them to shrink along orthogonal axes. This creates undulations 58 in each of the sheets 46, 50 between adjacent weld spots 54.

With continued reference to FIG. 3, the undulations 58 in the first sheet 46 define a first plurality of channels 62 extending in a first direction 66 and the undulations 58 in the second sheet 50 define a second plurality of channels 70 extending in a second direction 74 that is orthogonal to the first direction 66. As described in greater detail below, these channels 62, 70 allow fluid to flow through the structural side panels 22, 26 and to be stored within the panels 22, 26.

With reference to FIGS. 2 and 4, each of the structural side panels 22, 26 has a generally L-shaped cross-section and includes a first or vertical portion 78, a second or bottom portion 82, and a bend 84 between the vertical and bottom portions 78, 82. The illustrated bend 84 defines an included angle θ (FIG. 4) of about 90 degrees such that the bottom portions 82 are horizontal; however, in other embodiments the angle θ may vary. The vertical portions 78 define side walls 86, 90 of the enclosure 18, and the bottom portions 82 collectively define a bottom wall 94 (FIG. 2) of the enclosure 18 for supporting soil and plant material thereon. In the illustrated embodiment, each of the structural side panels 22, 26 is made of a single, continuous polymer panel that is thermoformed into the illustrated shape after undergoing the heat-shrinking process described above. In other embodiments, the side panels 22, 26 may be made of multiple discrete segments joined together (e.g., using a polymer welding process, adhesives, mechanical fasteners, etc.).

The first channels 62 extend continuously through the vertical and bottom portions 78, 82 of the side panels 22, 26 (FIG. 4). In the vertical portions 78, the first channels 62 include openings 98 into which fluid, such as water or a water and nutrient mixture, may be poured. In the bottom portions 82, the channels 62, 70 define a reservoir 102 in which the fluid poured through the vertical portions 78 may accumulate. Wicks 106 extend upward from the reservoir 102 and into the soil. The wicks 106 can draw fluid from the reservoir 102 via capillary action to diffuse the fluid into the soil.

With continued reference to FIGS. 2 and 4, the illustrated gardening bed 10 also includes an overflow trough or vessel 110 located between and beneath the bottom portions 82 of the side panels 22, 26. The overflow trough 110 collects any excess fluid that cannot be accommodated within the volume of the reservoir 102. Each of the side panels 22, 26 includes a second bend 104 to direct fluid from the reservoir 102 into the trough 110. The trough 110 may be removable for manual emptying or may include a valve, hose connector, or other means for draining fluid from the trough.

In some embodiments, the bends 104 may pinch the channels 62, creating a restriction to impede the fluid from freely flowing out of the reservoir 102. As such, excess fluid may only flow out of the reservoir 102 when there is sufficient pressure or head (e.g., due to excess fluid building up in the vertical portions 78 of the panels 22, 26) to force the fluid through the bends 104 . Alternatively or additionally, the angle θ may be reduced so that the fluid is retained in the reservoir under the influence of gravity.

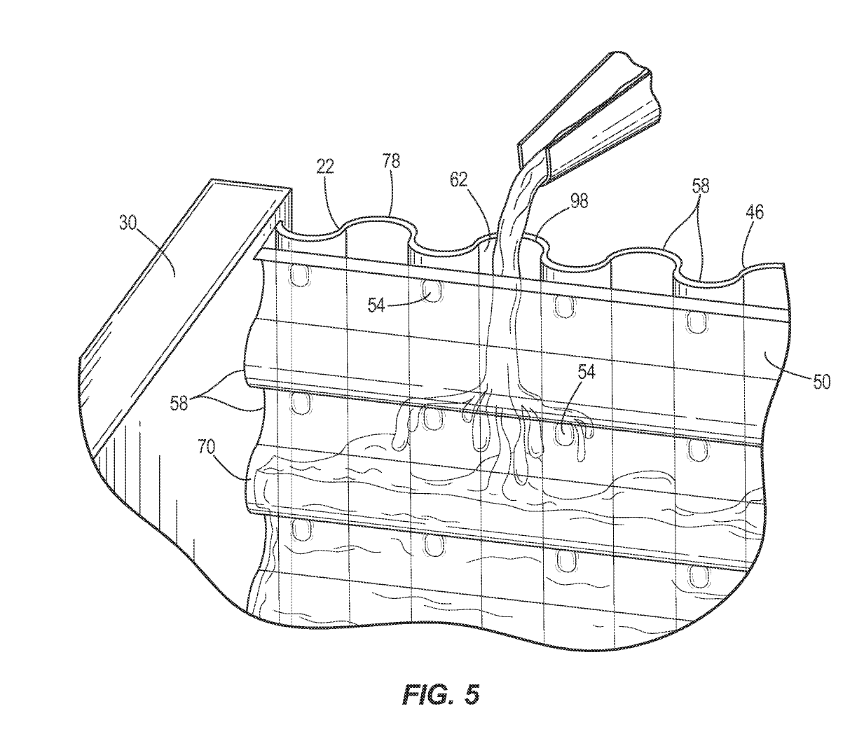

In operation, a user fills the enclosure 18 of the gardening bed 10 with soil and plant material, such as seeds, seedlings, and the like. As an alternative to pouring water directly on the soil, the user may pour water into the openings 98 in the side panels 22, 26 (FIG. 5). The water circulates downward through the channels 62 (i.e., between the interconnected polymer sheets 46, 50) and accumulates in the reservoir 102 located in the bottom portions 82 of the side panels 22, 26 (FIG. 4). The bottom ends of the wicks 106 are immersed in the accumulated water, causing water to be drawn upward and into the soil by capillary action. Excess water may be discharged from the reservoir 102 and into the overflow trough 110. In the illustrated embodiment, the structural side panels 22, 26 are semi-transparent, enabling the user to visually monitor the water level in the reservoir 102 and avoid over-watering.

Various features of the invention are set forth in the following claims.

What is claimed is:

1. A gardening bed comprising:
a frame; and
a structural panel coupled to the frame, the panel including
at least two interconnected layers of polymer material,
at least one channel defined between the layers, the channel having an opening into which a fluid may be poured, and
at least one reservoir defined between the layers in which fluid poured through the channel may accumulate.

2. The gardening bed of claim 1, further comprising at least one wick extending from the reservoir, the wick being configured to draw the fluid out of the reservoir.

3. The gardening bed of claim 1, wherein the structural panel includes a first portion at least partially defining a side wall of the gardening bed and a second portion at least partially defining a bottom wall of the gardening bed.

4. The gardening bed of claim 3, wherein the channel extends through the first portion, and wherein the reservoir is located within the second portion.

5. The gardening bed of claim 3, wherein the opening is located on the first portion.

6. The gardening bed of claim 1, further comprising an overflow vessel in fluid communication with the reservoir to receive and store excess fluid from the reservoir.

7. The gardening bed of claim 1, wherein the structural panel is a first structural panel, and wherein the gardening bed further comprises a second structural panel substantially identical to the first structural panel.

8. The gardening bed of claim 7, further comprising a first end panel and a second end panel spaced from the first end panel, wherein the first and second end panels cooperate with the first and second structural panels to define an enclosure configured to retain at least one of soil and plant material therein.

9. The gardening bed of claim 7, wherein the first and second structural panels are generally L-shaped.

10. The gardening bed of claim 1, wherein the layers are interconnected by a plurality of weld spots located at spaced intervals.

11. The gardening bed of claim 10, wherein the layers include undulations between adjacent weld spots.

12. The gardening bed of claim 11, wherein the channel and the reservoir are each at least partially defined by the undulations.

13. The gardening bed of claim 1, wherein the channel is one of a plurality of channels defined between the layers.

14. A structural panel for a gardening bed, the structural panel comprising:
a first portion;
a second portion extending generally perpendicularly from the first portion;
at least one channel extending through the first portion, the channel having an opening into which a fluid may be poured; and
at least one reservoir in which fluid poured through the channel may accumulate.

15. The structural panel of claim 14, wherein the opening is located on the first portion, and wherein the reservoir is located within the second portion.

16. The structural panel of claim 14, further comprising at least two interconnected layers of polymer material, wherein the channel is defined between the layers.

17. The structural panel of claim 16, wherein the layers are interconnected by a plurality of weld spots located at spaced intervals.

18. The structural panel of claim 17, wherein the layers include undulations between adjacent weld spots.

19. The structural panel of claim 18, wherein the channel and the reservoir are at least partially defined by the undulations.

20. The structural panel of claim 14, wherein the channel is one of a plurality of channels extending from the first portion to the second portion.
